(19) United States
(12) Patent Application Publication
(10) Pub. No.: US 2025/0344649 A1
(43) Pub. Date: Nov. 13, 2025

(54) NOVEL PLANT CULTIVATION DEVICE

(71) Applicant: Liuzeng Wang, Shenzhen (CN)

(72) Inventor: Liuzeng Wang, Shenzhen (CN)

(21) Appl. No.: 19/273,084

(22) Filed: Jul. 17, 2025

Related U.S. Application Data
(63) Continuation of application No. 18/438,524, filed on Feb. 12, 2024, now Pat. No. 12,389,838.

(51) Int. Cl. A01G 9/24; A01G 9/02; A01G 9/26

(52) U.S. Cl. CPC A01G 9/249; A01G 9/028; A01G 9/26

(57) ABSTRACT

The present disclosure discloses a novel plant cultivation device, which comprises a cultivation component and a plant lighting device; the cultivation component comprises a planting tray and a thermal insulation cover, and the thermal insulation cover is arranged above the planting tray and is provided with at least one mounting base that can receive and support the plant lighting device; the plant lighting device is configured to provide simulated sunlight for plants in a plurality of cultivation chambers, thereby promoting plant growth.

### TECHNICAL FIELD

The present disclosure relates to the field of plant cultivation technology, particularly to a novel plant cultivation device.

### BACKGROUND

Currently, hydroponic plant cultivation mainly relies on nutrient solutions to grow plants. Existing plant cultivation devices simply provide the function of holding plants and nutrient solutions. During use, cultivators, unable to tend to the plants for extended periods, fail to supply adequate nutrients and comfortable conditions promptly, resulting in plant damage, poor cultivation outcomes, or even death.

U.S. Pat. No. 10,531,618 discloses a plant incubator apparatus that offers convenient control over air circulation and liquid nutrient levels to enable optimal plant growth under controlled conditions. However, the cultivation temperature of this device fluctuates with ambient temperature changes, failing to provide a comfortable cultivation temperature for plants.

U.S. Pat. No. 12,597,117 discloses a germination or growth apparatus and a plant cultivation apparatus capable of increasing carbon dioxide concentration in an insulated chamber and controlling the cultivation temperature to promote plant growth.

In view of the above, a novel plant cultivation device is provided, which can control the cultivation temperature within the device through a new technology. At the same time, the device can also provide plants with comfortable sunlight, humidity, and other natural factors required for growth, thereby promoting plant cultivation and enabling optimal growth under controlled conditions.

### SUMMARY

The present disclosure provides a new plant cultivation device, comprising a cultivation component and a plant lighting device.

The cultivation component comprises a planting tray and a thermal insulation cover. The planting tray has a plurality of cultivation chambers, and the thermal insulation cover is arranged above the planting tray to enclose and seal the planting tray. One or more installation cavities with an extension length are arranged on a top surface of the thermal insulation cover for receiving and supporting the plant lighting device.

The installation cavity is provided with one or more ventilation holes. The installation cavity is provided with a slide rail, along which the plant lighting device slides, and the plant lighting device is configured not only for providing illumination but also for opening or closing the ventilation holes.

This solution involves setting up installation cavities on the top surface of the thermal insulation cover, ventilation holes and slide rails on the installation cavities, and placing the plant lighting device on the slide rails. By moving the plant lighting device, the ventilation holes can be opened or closed. The plant lighting device serves both as a light source and a switch for the ventilation holes, making the cultivation device structurally simple, cost-effective, and easy to operate.

The present disclosure further provides a new plant cultivation device, comprising a cultivation component and a temperature control apparatus. The cultivation component comprises a planting tray and a thermal insulation cover, wherein the planting tray has a plurality of cultivation chambers, and the thermal insulation cover is placed above the planting tray to enclose and seal the planting tray. One or more installation cavities with an extension length are arranged on a top surface of the thermal insulation cover, with a plant lighting device in each of the installation cavities.

The installation cavity is provided with one or more ventilation holes, and a slide rail is arranged on the installation cavity, allowing the plant lighting device to slide along the slide rail to open or close the ventilation holes.

The temperature control apparatus comprises a heating component and a control component, and the control component is configured to regulate the operation of the heating component. The heating component has a rectangular structure, wrapped in a layer of waterproof material, and is electrically connected to the control component.

In this solution, by arranging an installation cavity on the top surface of the thermal insulation cover, providing ventilation holes and slide rails on the installation cavity, and mounting a plant lighting device on the slide rail, the ventilation holes can be opened or closed by moving the plant lighting device. The plant lighting device not only provides illumination but also functions as a switch for the ventilation holes. The control component is configured to activate the heating component when the temperature is low, heating the planting tray to promote seed germination or plant growth. Typically, the planting tray is designed in a rectangular shape, allowing the rectangular heating component to better fit the planting tray.

The present disclosure further provides a novel plant cultivation device, comprising a cultivation component and a temperature control apparatus.

The cultivation component comprises a planting tray and a thermal insulation cover. The planting tray has a plurality of cultivation chambers, and the thermal insulation cover is detachably arranged above the planting tray to enclose and seal the planting tray. One or more installation cavities with an extension length are arranged on a top surface of the thermal insulation cover, and a plant lighting device is arranged in each of the installation cavities.

The installation cavity is provided with one or more ventilation holes, and a slide rail is arranged on the installation cavity, allowing the plant lighting device to slide along the slide rail to open or close the ventilation holes.

The temperature control apparatus comprises a heating component and a control component; the control component comprises a PCB board and a control switch, which is electrically connected to the PCB board; and the heating component is electrically connected to the PCB board.

The control component further comprises a non-contact control module, which is electrically connected to the PCB board.

In this solution, by arranging an installation cavity on the top surface of the thermal insulation cover, providing ventilation holes and slide rails on the installation cavity, and mounting a plant lighting device on the slide rail, the ventilation holes can be opened or closed by moving the plant lighting device. The plant lighting device not only provides illumination but also functions as a switch for the ventilation holes. The control component is configured to activate the heating component when the temperature is low, heating the planting tray to promote seed germination or plant growth. By incorporating a non-contact control module on the PCB board, the plant's growing environment can be wirelessly monitored remotely, and the heating temperature can be controlled remotely, enhancing convenience of use.

### BRIEF DESCRIPTION OF THE DRAWINGS

FIG. 1 is a schematic diagram of the overall structure of Embodiment 1 of the present disclosure.

FIG. 2 is an exploded view of the structure of Embodiment 1 of the present disclosure.

FIG. 3 is a schematic diagram of the thermal insulation cover and plant lighting device in Embodiment 1 of the present disclosure.

FIG. 4 is an enlarged view of section A in FIG. 3.

FIG. 5 is a schematic diagram of another slide rail structure in Embodiment 1 of the present disclosure.

FIG. 6 is a schematic diagram of the structure of Embodiment 2 of the present disclosure.

FIG. 7 is a schematic diagram of the measurement apparatus in the present disclosure.

FIG. 8 is a schematic diagram of the heating component in the present disclosure.

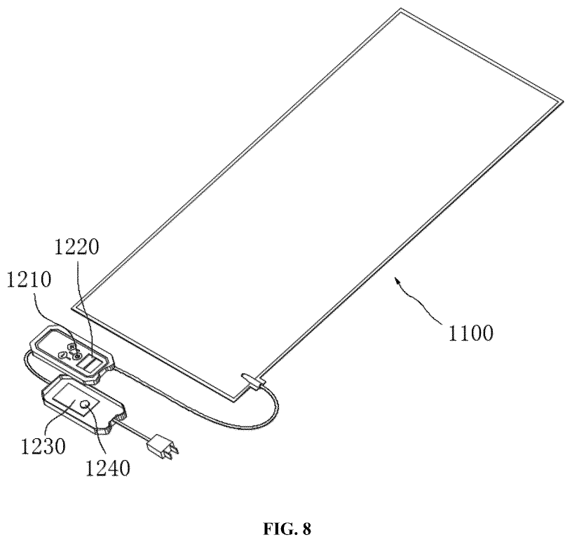

FIG. 9 is a schematic diagram of Embodiment 3 of the present disclosure.

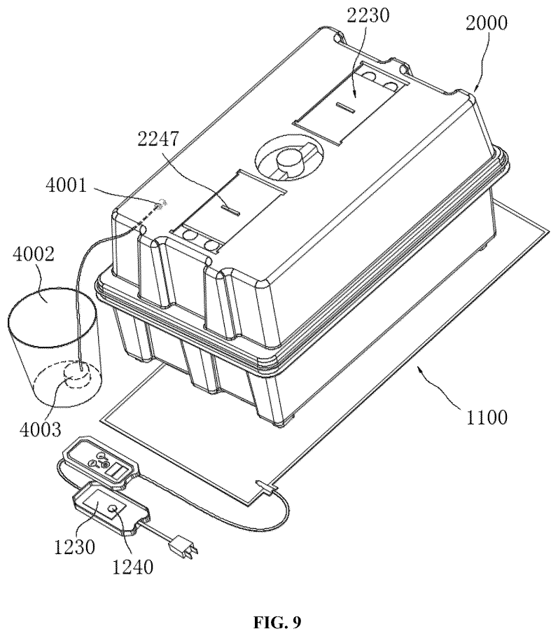

FIG. 10 is a schematic diagram of the watering apparatus in the present disclosure.

FIG. 11 is a schematic diagram of Embodiment 4 of the present disclosure.

FIG. 12 is an enlarged view of section B in FIG. 11.

### DESCRIPTION OF EMBODIMENTS

The following provides a further detailed explanation of the present disclosure with reference to the accompanying drawings and embodiments.

### Embodiment 1

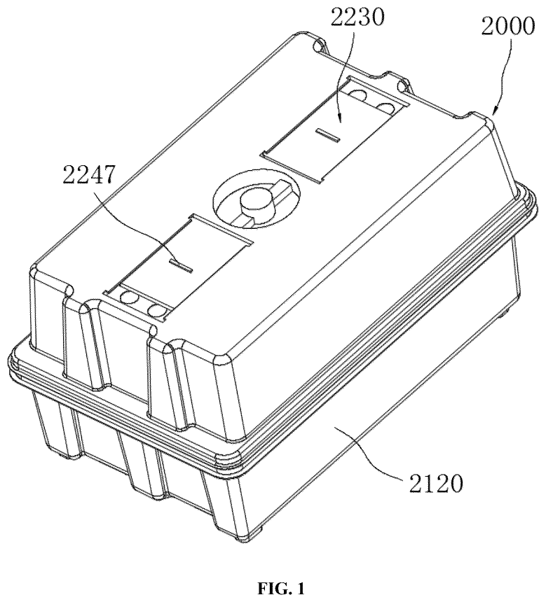

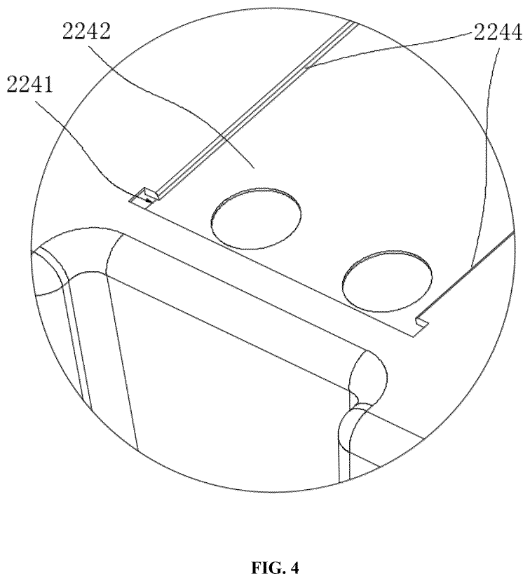

As shown in FIGS. 1 to 5, a novel plant cultivation device includes a cultivation component 2000 and a plant lighting device 2230.

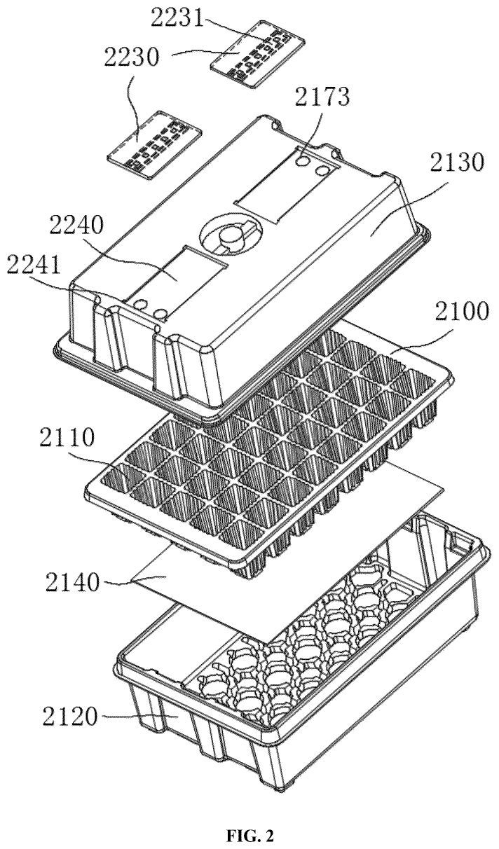

As shown in FIG. 2, the cultivation component 2000 includes a planting tray 2100 and a thermal insulation cover 2130.

The planting tray 2100 has a plurality of cultivation chambers 2110, and the thermal insulation cover 2130 is placed over the planting tray 2100, enclosing and sealing the planting tray 2100.

On the top surface of the thermal insulation cover 2130, there are one or more installation cavities 2240 with an extension length, which can receive and support the plant lighting device 2230.

The installation cavity 2240 is provided with one or more ventilation holes 2173. A slide rail 2241 is provided on the installation cavity 2240, allowing the plant lighting device 2230 to slide along the slide rail 2241. The plant lighting device 2230 not only provides illumination but can also be used to open or close the ventilation holes 2173.

In this embodiment, as shown in FIGS. 2 to 4, there are two installation cavities 2240. Each installation cavity 2240 has a connected bottom wall 2242 and side walls 2243. Bosses 2244 are provided on the opposing side walls of the installation cavity 2240, arranged along the extension direction of the installation cavity 2240. The two opposing bosses 2244, together with the bottom wall 2242 and side wall 2243 of the installation cavity 2240, form the slide rail 2241.

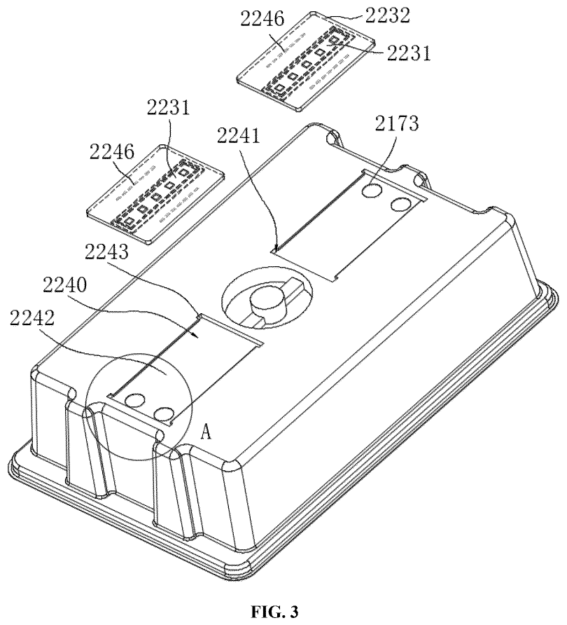

In this embodiment, as shown in FIG. 3, both the installation cavity 2240 and the plant lighting device 2230 have a rectangular cross-section. The plant lighting device 2230 includes a shell 2232 and a light bar 2231 mounted on the shell 2232.

To reduce friction between the plant lighting device 2230 and the installation cavity 2240, two or more sliders 2246 are provided on the shell 2232 on the light-emitting side. The sliders 2246 are positioned on two sides of the light bar 2231 respectively.

In this embodiment, as shown in FIG. 1, to facilitate moving the plant lighting device 2230, a pushing part 2247 is provided on the shell 2232 opposite the light-emitting side.

Alternatively, a notch can be made on the shell 2232 to push the plant lighting device 2230.

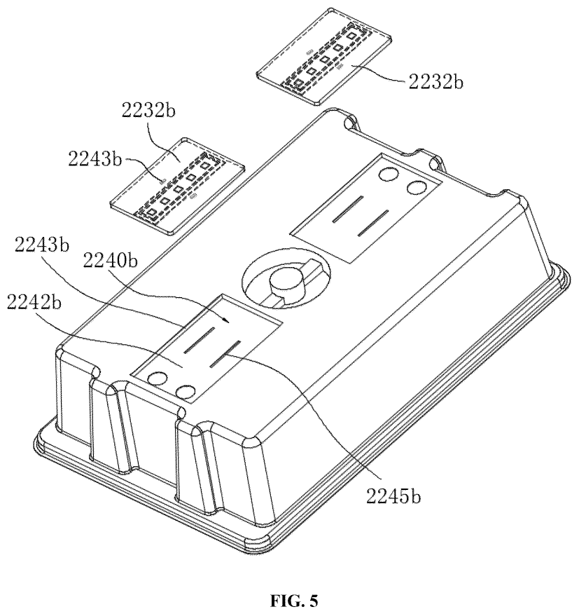

As shown in FIG. 5, as an alternative structure for the slide rail, the installation cavity 2240b has a connected bottom wall 2242b and side wall 2243b. The slide rail 2241b is a through hole 2245b formed in the bottom wall 2242b, and the through hole 2245b is arranged along the extension direction of the installation cavity 2240b.

A fastening buckle 2233b is provided at the bottom of the shell 2232b at a position corresponding to the through hole 2245b. The cross-section of the fastening buckle 2233b is inverted T-shaped, and it passes through the through hole 2245b to be hooked onto the bottom of the shell 2232b, preventing the plant lighting device from easily falling when moving the thermal insulation cover.

As shown in FIG. 3, a lifting part 2162 is set at the center of the top surface of the thermal insulation cover 2130. The two installation cavities 2240 are symmetrically arranged relative to the lifting part 2162. This configuration is suitable for large-scale cultivation equipment, and the number of plant lighting devices 2230 is determined by the size of the cultivation equipment.

The cultivation component 2000 also includes a lower shell 2120, and the planting tray 2100 is placed inside the lower shell 2120. To enhance moisture retention and water storage performance, water-absorbing cotton 2140 is placed beneath the planting tray 2100.

In this embodiment, the thermal insulation cover 2130 is made of a transparent rigid material, allowing the light emitted by the plant lighting device 2230 to pass through and provide simulated sunlight for the plants.

In this solution, the installation cavity 2240 is arranged on the top surface of the thermal insulation cover 2130, the ventilation holes 2173 and the slide rail 2241 are arranged on the installation cavity 2240, and the plant lighting device 2230 is arranged on the slide rail 2241. As such, the ventilation holes 2173 can be opened or closed by moving the plant lighting device 2230. While providing illumination, the plant lighting device 2230 also serves as a switch for the ventilation holes 2173, making the cultivation device structurally simple, cost-effective, and easy to operate.

### Embodiment 2

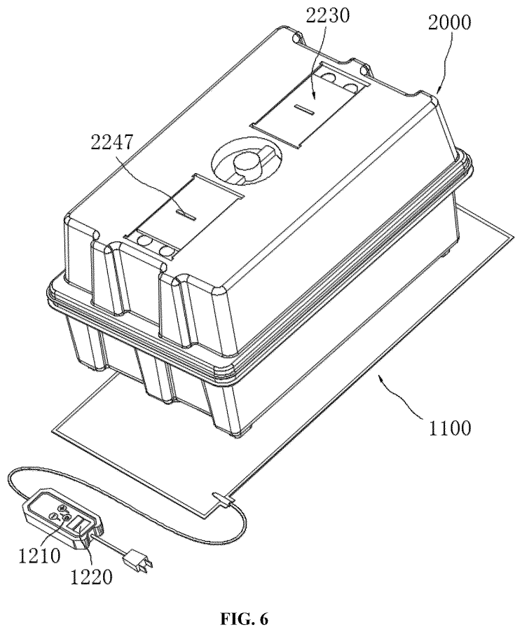

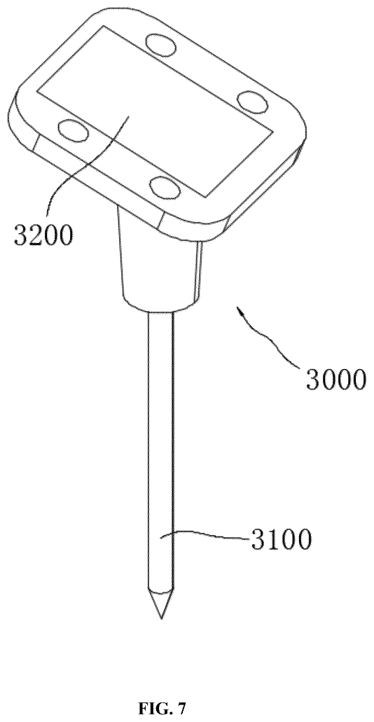

As shown in FIGS. 6 and 7, to enhance the adaptability of the cultivation equipment and ensure its operation in low temperatures, this solution expands on Embodiment 1 by adding a temperature control apparatus 1000.

The temperature control apparatus 1000 includes a heating component 1100 and a control component 1200. The control component 1200 is used to regulate the operation of the heating component 1100.

The heating component 1100 has a rectangular structure, wrapped in a layer of waterproof material, giving it both heating and waterproof functions. The heating component 1100 is connected to the control component 1200 through wires, establishing an electrical connection with the control component 1200.

In other embodiments (not shown), the shape of the heating component 1100 is not limited to a rectangular structure and can also be circular, elliptical, diamond-shaped, or other irregular or curved-edge structures.

The control component 1200 includes a control switch 1210 and a display screen 1220, through which the temperature value of the heating component 1100 can be monitored.

As shown in FIG. 7, the cultivation equipment also includes a measurement apparatus 3000. The measurement apparatus 3000 includes at least one probe 3100, which extends into the soil within the cultivation chamber 2110 to obtain the temperature value of the soil. based on the temperature value, the user adjusts the heating component 1100 using the control component 1200.

Of course, the probe 3100 can also be placed inside the cultivation component to obtain the ambient temperature inside the cultivation component.

In addition, the probe 3100 can also be placed in the heating component 1100 to obtain the temperature value of the heating component 1100.

In this embodiment, the heating component 1100 is preferably a fixed-power heating component, with its heating power set at the factory to the temperature most conducive to plant growth.

In this solution, the installation cavity 2240 is arranged on the top surface of the thermal insulation cover 2130, the ventilation holes 2173 and the slide rail 2241 are arranged on the installation cavity 2240, and the plant lighting device 2230 is placed on the slide rails 2241. As such, the ventilation holes 2173 can be opened or closed by moving the plant lighting device 2230. The plant lighting device 2230 not only provides illumination but also serves as a switch for the ventilation holes 2173. The control component 1200 can activate the heating component 1100 when the temperatures are low, heating the planting tray 2100 to promote seed germination or plant growth. Typically, both the planting tray 2100 and the heating component 1100 are designed in a rectangular shape, allowing the rectangular heating component 1100 to better fit the planting tray 2100 and effectively improve land utilization.

### Embodiment 3

People's demands for product functionality are increasing, such as heating temperature adjustment, remote monitoring and control of environmental temperature and humidity within cultivation equipment, and automatic watering.

Therefore, the inventors have further expanded and improved upon Embodiment 2.

As shown in FIG. 2, the cultivation component further includes a lower shell 2120, with the planting tray 2100 placed inside the lower shell 2120. The lower shell 2120 has an accommodation depth greater than the height of the planting tray 2100. Below the planting tray 2100, water-absorbing cotton 2140 is provided, and the water-absorbing cotton 2140 is supported by a support bracket.

The bottom of the lower shell 2120 features circular recessed holes, and the support bracket has at least four support feet that extend downward and taper gradually, matching the shape of the recessed holes. The support feet are fixed within the recessed holes.

The edge of the thermal insulation cover 2130 extend outward and downward to form a connection part, allowing the thermal insulation cover 2130 to cover the lower shell 2120 through the connection part.

In addition to the control switch 1210, the control component 1200 also includes a PCB board 1230 and a display screen 1220. The control switch 1210, the display screen 1220, and the heating component 1100 are all electrically connected to the PCB board 1230.

As shown in FIG. 7, in this embodiment, the measurement apparatus 3000 includes a numerical screen 3200 and a probe 3100. The numerical screen 3200 is connected above the probe 3100, and the probe 3100 can measure the temperature and humidity values of the soil. The numerical screen 3200 displays the temperature and humidity values detected by the probe 3100, allowing the users to control the operation of the heating component 1100 through the control component 1200 based on the temperature values.

The control component 1200 further includes a non-contact control module 1240, which is electrically connected to the PCB board 1230.

In this embodiment, the non-contact control module 1240 is one of a Bluetooth module, a WIFI transmission module, or a RF module. Users can utilize a terminal, such as a mobile phone, to exchange data with the non-contact control module 1240 for remote control.

The cultivation component also includes a spraying apparatus, which is electrically connected to the control component 1200. When the probe 3100 detects a low humidity, the control component 1200 activates the spraying apparatus to spray water.

The spraying apparatus includes a spray nozzle 4001 installed on the inner wall of the thermal insulation cover 2130. A water tank 4002 and a water pump 4003 are located either inside the lower shell 2120 or outside the cultivation device. The water pump 4003 is connected to the spray nozzle 4001 through a water pipe and is electrically connected to the control component 1200.

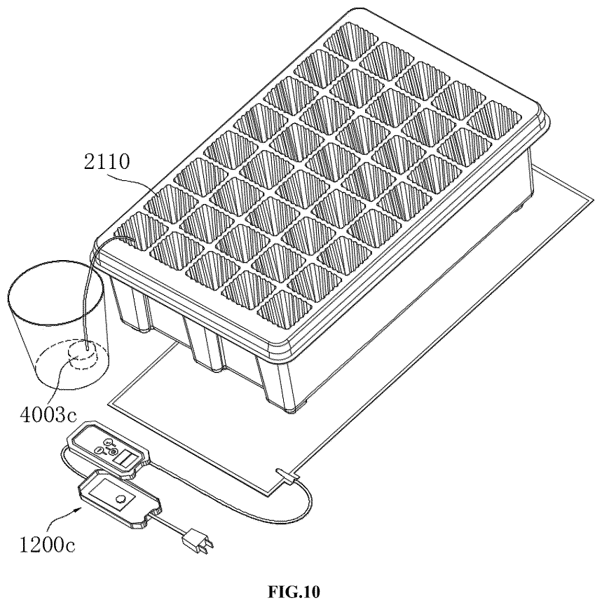

As shown in FIG. 10, the cultivation component further includes a watering apparatus, which is electrically connected to the control component 1200c, and when the measurement apparatus 3100 detects a low humidity, the control component 1200c activates the watering apparatus to spray water.

In this embodiment, the watering apparatus includes a water pump 4003c electrically connected to the control component 1200c, the inlet end of the water pump 4003c is connected to the water source, and the outlet end of the water pump 4003c extends to the interior of the cultivation component through a water pipe, or the outlet end of the water pump 4003c is inserted into the soil within the cultivation chamber 2110.

In this solution, the installation cavity 2240 is arranged on the top surface of the thermal insulation cover 2130, the ventilation holes 2173 and the slide rail 2241 are arranged on the installation cavity 2240, and the plant lighting device 2230 is placed on the slide rail 2241. As such, the ventilation holes 2173 can be opened or closed by moving the plant lighting device 2230. The plant lighting device 2230 not only provides illumination but also functions as a switch for the ventilation holes 2173. The control component 1200 activates the heating component 1100 when the temperatures are low, heating the planting tray to promote seed germination or plant growth. By incorporating a non-contact control module 1240 on the PCB board 1230, the plant growth environment can be wirelessly monitored remotely, and the heating component 1100 and water pump 4003 can be controlled remotely, thereby enhancing convenience of use.

### Embodiment 4

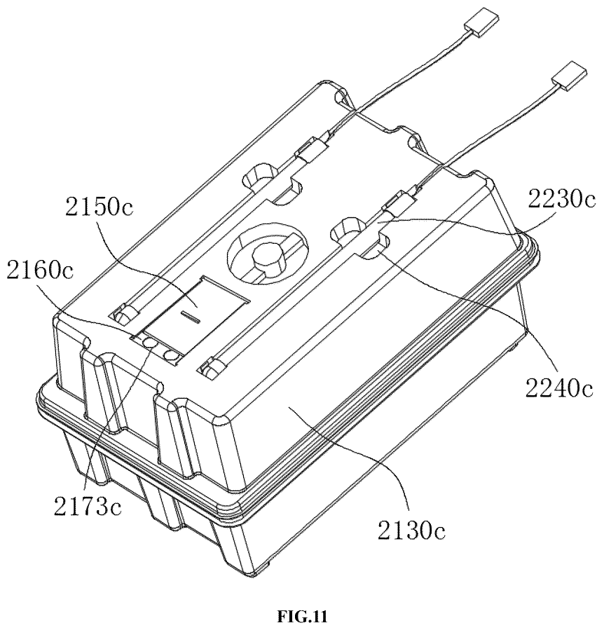

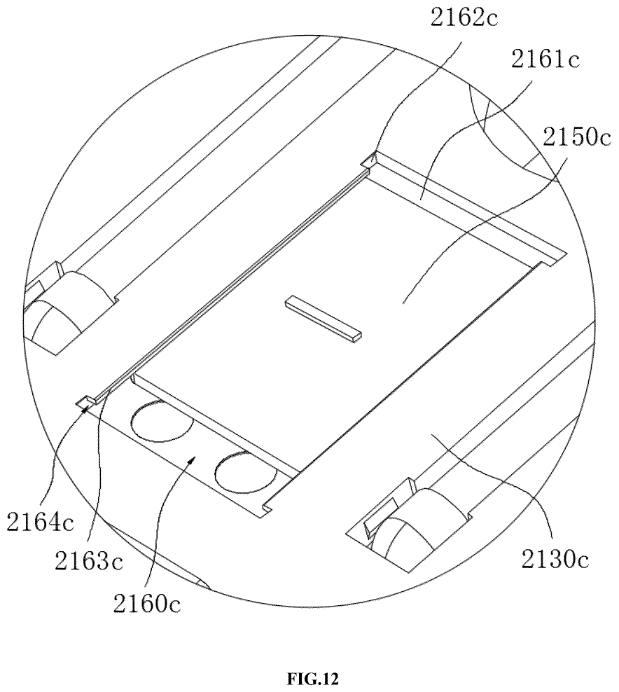

As shown in FIGS. 11 and 12, this embodiment provides another combination of plant lighting device and ventilation holes.

Due to the only difference between this embodiment and embodiments 1-3 being the plant lighting device and ventilation holes installed on the thermal insulation cover 2130c, this embodiment only provides further explanation of the distinguishing features.

One or more first installation cavities 2240c with an extension length are arranged on a top surface of the thermal insulation cover 2130c; a plant lighting device 2230c is arranged within the first installation cavity 2240c, and the setting method of the plant lighting device 2230c is the same as in the master plan, which will not be repeated here.

The thermal insulation cover 2130c is provided with one or more ventilation holes 2173c; the thermal insulation cover 2130c is further provided with a cover plate 2150c, and the cover plate 2150c is configured for opening or closing the ventilation holes 2173c.

In this embodiment, one or more second installation cavities 2160c with an extension length are arranged on a top surface of the thermal insulation cover, the second installation cavity 2160c has a second bottom wall 2161c and second side walls 2162c connected to each other, and second bosses 2163c are provided on two opposite side walls of the second installation cavity 2160c. The second bosses 2163c are arranged along an extension direction of the second installation cavity 2160c, two opposite second bosses 2163c, together with the second bottom wall 2161c and second side walls 2162c of the second installation cavity 2160c, form the second slide rail 2164c, and the cover plate 2150c slides within the second slide rail 2164c.

This scheme uses a strip-shaped plant lighting device, which is suitable for large-sized cultivation device.

What is claimed is:

1. A novel plant cultivation device, comprising a cultivation component and a plant lighting device, wherein
the cultivation component comprises a planting tray and a thermal insulation cover, wherein the planting tray has a plurality of cultivation chambers, and the thermal insulation cover is arranged above the planting tray to enclose and seal the planting tray; and wherein one or more installation cavities with an extension length are arranged on a top surface of the thermal insulation cover for receiving and supporting the plant lighting device; and
the installation cavity is provided with one or more ventilation holes; the installation cavity is provided with a slide rail, along which the plant lighting device slides, and the plant lighting device is configured not only for providing illumination but also for opening or closing the ventilation holes.

2. The novel plant cultivation device according to claim 1, wherein the installation cavity has a bottom wall and side walls connected to each other, and bosses are provided on two opposite side walls of the installation cavity, wherein the bosses are arranged along an extension direction of the installation cavity, and two opposite bosses, together with the bottom wall and side walls of the installation cavity, form the slide rail.

3. The novel plant cultivation device according to claim 1, wherein the installation cavity has a bottom wall and side walls connected to each other, the slide rail is a through hole arranged on the bottom wall, and the through hole is arranged along an extension direction of the installation cavity.

4. The novel plant cultivation device according to claim 1, wherein a lifting part is arranged at a center of a top of the thermal insulation cover, and wherein a number of installation cavities is two, and the two installation cavities are symmetrically arranged relative to the lifting part.

5. The novel plant cultivation device according to claim 2, wherein both the installation cavity and the plant lighting device have a rectangular cross-section, and the plant lighting device comprises a shell and a light bar arranged on the shell; and
two or more sliders are provided on the shell on the light-emitting side, and the sliders are respectively arranged on both sides of the light bar; and
a pushing part is provided on the shell opposite to a light-emitting side.

6. The novel plant cultivation device according to claim 3, wherein the plant lighting device comprises a shell and a light bar arranged on the shell, a fastening buckle is provided on the shell, and the shell is slidably mounted within the through hole through the fastening buckle.

7. The novel plant cultivation device according to claim 1, wherein the cultivation component further comprises water-absorbing cotton positioned below the planting tray; and
the thermal insulation cover is made of a transparent rigid material, allowing light emitted by the plant lighting device to pass through the thermal insulation cover to provide simulated sunlight for the plants.

8. A novel plant cultivation device, comprising a cultivation component and a temperature control apparatus, wherein
the cultivation component comprises a planting tray and a thermal insulation cover, wherein the planting tray has a plurality of cultivation chambers, and the thermal insulation cover is arranged above the planting tray to enclose and seal the planting tray; and wherein one or more first installation cavities with an extension length are arranged on a top surface of the thermal insulation cover, and a plant lighting device is arranged in the first installation cavity; and
the thermal insulation cover is provided with one or more ventilation holes, and the thermal insulation cover is further provided with a cover plate configured for opening or closing the ventilation holes;
the temperature control apparatus comprises a heating component and a control component, and the control component is configured to regulate the operation of the heating component;
the control component comprises a control switch and a display screen, and a temperature value of the heating component is obtainable from the display screen; and
the heating component has a rectangular structure, wrapped in a layer of waterproof material, and is electrically connected to the control component through wires;
the cultivation component further comprises a measurement apparatus, and the measurement apparatus is used to obtain ambient temperatures of the soil in the cultivation chambers and the cultivation components, or the temperature value of the heating components.

9. The novel plant cultivation device according to claim 8, wherein one or more second installation cavities with an extension length are arranged on a top surface of the thermal insulation cover, the second installation cavity has a second bottom wall and second side walls connected to each other, and second bosses are provided on two opposite side walls of the second installation cavity, wherein the second bosses are arranged along an extension direction of the second installation cavity, two opposite second bosses, together with the second bottom wall and second side walls of the second installation cavity, form the second slide rail, and the cover plate slides within the second slide rail.

10. The novel plant cultivation device according to claim 8, wherein the measurement apparatus inserted into soil within the cultivation chamber to obtain the temperature value of the soil, and the user controls the heating component using the control component based on the temperature value.

11. The novel plant cultivation device according to claim 10, wherein the measurement apparatus is located in the space inside the cultivation component and is used to measure the ambient temperature inside the cultivation component.

12. A novel plant cultivation device, comprising a cultivation component and a temperature control apparatus, wherein
the cultivation component comprises a planting tray and a thermal insulation cover, wherein the planting tray has a plurality of cultivation chambers, and the thermal insulation cover is detachably arranged above the planting tray to enclose and seal the planting tray; and wherein one or more first installation cavities with an extension length are arranged on a top surface of the thermal insulation cover, and a plant lighting device is arranged in each of the first installation cavities; and
the thermal insulation cover is provided with one or more ventilation holes, and the thermal insulation cover is provided with a cover plate configured for opening or closing the ventilation holes; and
the temperature control apparatus comprises a heating component and a control component, wherein the control component comprises a PCB board, and the heating component is electrically connected to the PCB board; and
the control component further comprises a non-contact control module, which is electrically connected to the PCB board.

13. The novel plant cultivation device according to claim 12, wherein one or more second installation cavities with an extension length are arranged on a top surface of the thermal insulation cover, the second installation cavity has a second bottom wall and second side walls connected to each other, and second bosses are provided on two opposite side walls of the second installation cavity, wherein the second bosses are arranged along an extension direction of the second installation cavity, two opposite second bosses, together with the second bottom wall and second side walls of the second installation cavity, form the second slide rail, and the cover plate slides within the second slide rail.

14. The novel plant cultivation device according to claim 12, wherein the non-contact control module is a Bluetooth module, a WIFI transmission module, or a RF module;
the control component further comprises a control switch, which is electrically connected to the PCB board.

15. The novel plant cultivation device according to claim 12, wherein the cultivation device further comprises a measurement apparatus inserted into soil of the cultivation chamber to obtain temperature and humidity values of the soil, and wherein the measurement apparatus communicates with the control component to transmit the measured temperature and humidity values to the control component.

16. The novel plant cultivation device according to claim 12, wherein the cultivation component further comprises a lower shell, and the planting tray is placed inside the lower shell, wherein the lower shell has an accommodation depth greater than a height of the planting tray; and water-absorbing cotton is arranged below the planting tray and supported by a support bracket.

17. The novel plant cultivation device according to claim 16, wherein a bottom of the lower shell has circular recessed holes, the support bracket has at least four support feet extending downward and tapering gradually, with a shape matching the recessed holes, wherein the support feet are fixed within the recessed holes.

18. The novel plant cultivation device according to claim 16, wherein an edge of the thermal insulation cover extends outward and downward to form a connection part, and the thermal insulation cover is fitted over the lower shell through the connection part.

19. The novel plant cultivation device according to claim 15, wherein the cultivation component further comprises a watering apparatus, which is electrically connected to the control component, and when the measurement apparatus detects a low humidity, the control component activates the watering apparatus to spray water.

20. The novel plant cultivation device according to claim 16, wherein the watering apparatus comprises a water pump electrically connected to the control component, the inlet end of the water pump is connected to the water source, and the outlet end of the water pump extends to the interior of the cultivation component through a water pipe.
